(19) United States
(12) Patent Application Publication
(10) Pub. No.: US 2005/0283356 A1
(43) Pub. Date: Dec. 22, 2005

(54) Data management method

(76) Inventor: John C. Wang, Taoyuan City (TW)

Correspondence Address: RABIN & BERDO, P.C., Suite 500, 1101 14 Street, N.W., Washington, DC, 20005, US

(21) Appl. No.: 11/045,054

(22) Filed: Jan. 31, 2005

(30) Foreign Application Priority Data
Jun. 16, 2004 (TW) 93117341

(51) Int. Cl. G06F 17/30; G06F 3/00

(52) U.S. Cl. 704/2

(57) ABSTRACT

The present invention relates to a data management method between a mass storage device and a data capture/storage device. When the data capture/storage device is connected to the mass storage device, a connection signal is generated. The connection signal initiates the transfer of data files from the data capture/storage device to the mass storage device. Then, a first marker is added to the data files in the data capture/storage device, so the transferred data files can be differentiated from the not-yet transferred.

### RELATED APPLICATIONS

The present application is based on, and claims priority from, Taiwan Application Serial Number 93117341, filed Jun. 16, 2004, the disclosure of which is hereby incorporated by reference herein in its entirety. The present application was also disclosed in Disclosure Document NO. 547,707, filed on Feb. 27, 2004 under 35 U.S.C. 122 and 37 C.F.R. 1.14.

### BACKGROUND

1. Field of Invention

The present invention relates to a data management method. More particularly, the present invention relates to a data management method between a mass storage device and a data capture/storage device.

2. Description of Related Art

With the advance in digital consumer electronics, digital capture/storage devices, such as digital cameras and digital recorders, have become even more popular and pervasive. However, because of cost considerations, most digital capture/storage devices are equipped with only a small-capacity memory for temporary storage. Once the storage is full, the user has to transfer the stored data to a mass storage device, such as a hard disk or a CD-ROM, before he can further store new data.

For example, when using the digital camera to take pictures, the user has to transfer the captured images from the digital camera to a personal computer for storage from time to time. If the user doesn't perform this backup procedure routinely, he may not have enough storage capacity to save new images at some point in the future. When the camera runs out of available storage, the user may delete old images to free up additional storage space. However, the user may have a problem recalling which pictures in the digital camera have already been saved on the personal computer and therefore may be deleted, and which ones haven't. Consequently, the user may accidentally delete images that should have been retained. As a result, these images are irrecoverably lost.

Further compounding the problem, when the user wants to backup the images in the digital camera to the personal computer, he or she often has to execute particular software for image transfer or management. The operation of the software may be complicated, particularly for persons who are not conversant with computer operations. Additionally, the user often has to select the images to transfer and then manually erase images just transferred. If the user doesn't immediately erase the transferred images in the digital camera, he or she may later have difficulty remembering which images have already been transferred and which have not. The traditional media management practice as described is inconvenient and inflexible.

### SUMMARY

For the forgoing reasons, there is a need for an improved data management method so the user can manage data between a data capture/storage device and a mass storage device more easily and conveniently. Using this method, the user doesn't have to perform the backup procedure manually, and accidental deletion can be avoided.

It is therefore an objective of the present invention to provide a data management method between a mass storage device and a data capture/storage device.

It is another objective of the present invention to provide a data capture/storage device having a data management function.

In accordance with the foregoing and other objectives of the present invention, a data management method is proposed. First, a connection signal is generated when a data capture/storage device is connected to a mass storage device. Then, data files in the data capture/storage device are transferred to the mass storage device via a transfer medium when the mass storage device and the data capture/storage device receive a connection signal. A first marker is then added to the data files in the data capture/storage device, so the transferred data files can be differentiated from the not-yet transferred.

According to another objective of the present invention, a data capture/storage device having a data management function is proposed. The data capture/storage device includes a processing unit, a detection unit, and a transfer unit. The detection unit connects to the processing unit for detecting the connection between the data capture/storage device and a mass storage device. When the data capture/storage device connects to the mass storage device, the detection unit generates a connection signal. The transfer unit also connects to the processing unit. When the processing unit receives the connection signal, the transfer unit transfers data files in the data capture/storage device to the mass storage device via a transfer medium. The processing unit adds a first marker to the data files in the data capture/storage device.

According to the present invention, transferring the data files in the data capture/storage device to a mass storage device can occur automatically, so that the data files in the data capture/storage device can be transferred to the mass storage device without additional manual intervention, and subsequent erroneous deletion of not-yet transferred data files in the data capture/storage device can be avoided. Furthermore, the user can retain the preferred data files in the data capture/storage device by adding a second marker. The data files with the second marker are not erased when the user performs the deletion function, even if such data files have already been transferred to the mass storage device and therefore bear the first marker.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 is a flowchart illustrating data management according to the present invention;

FIGS. 2 to 10 are drawings illustrating one preferred embodiment of the present invention; and

FIG. 11 is a block diagram illustrating the data capture/storage device according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

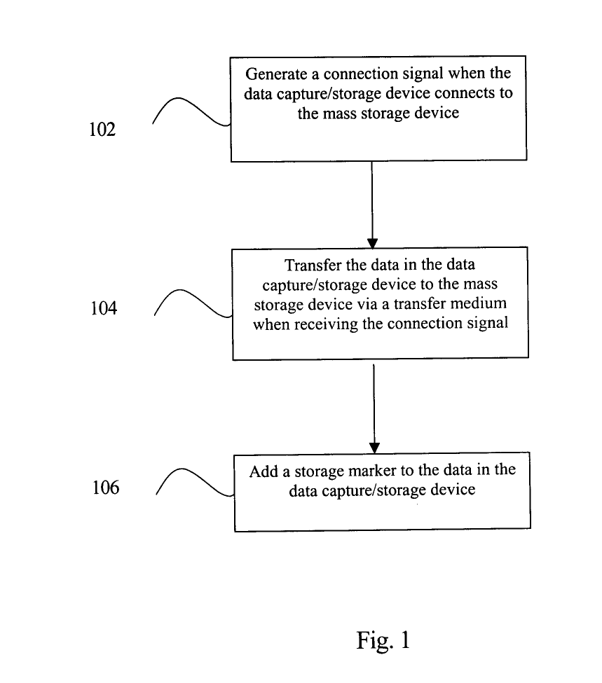

FIG. 1 is a flowchart illustrating a data management method according to the present invention. The data management method according to the present invention is employed to manage data files between the mass storage device and the data capture/storage device. The storage capacity of the mass storage device is preferably at least ten times that of the data capture/storage device. The data capture/storage device stores data files captured by the user, and a first marker can be added to the data files.

The data management method according to the present invention can automatically backup data files in the data capture/storage device to a mass storage device. Additionally, by adding a first marker to the data files when the backup process takes place, the backed-up and not yet backed-up data files can be distinguished to prevent the erroneous deletion of the not yet backed-up data files.

The first step of the data management method according to the present invention is to generate a connection signal when the data capture/storage device connects to the mass storage device (step 102). Then, the data files in the data capture/storage device are transferred to the mass storage device via a transfer medium when receiving the connection signal (step 104). A first marker is then added to the data files in the data capture/storage device (step 106).

The user can delete the data files tagged with the first marker by a command. Alternatively, whenever more storage space is needed on the data capture/storage device, those tagged with the first marker are deleted automatically. Therefore, the user doesn't have to perform the backup and the deletion procedures manually.

Furthermore, the user can retain the preferred data files in the data capture/storage device by adding a second marker. The data files tagged with the second marker are not deleted, even if already tagged with the first marker. This way, the user can preserve the desired data files in the data capture/storage device.

The data capture/storage device can be a digital image capture/storage device, such as a digital camera, a camera PDA, a camera mobile phone, a data scanner, or a bar code scanner. The data capture/storage device can also be a digital voice capture/storage device, such as a digital recorder. Examples of data files include images or video clips.

Examples of mass storage devices include personal computers, servers, network mass storage devices, photo printers with onboard storage, media center mass storage devices, companion picture vaults, or removable mass storage devices.

The transfer media can be wired or wireless. Examples include Firewire (IEEE-1394), serial cable, WiFi wireless, Bluetooth wireless, or Internet. Further, a recharging cable, such as a recharging USB cable, can also be employed. The data management can be incorporated into the recharging process such that when the user uses the recharging USB cable for recharging the data capture/storage device, the management task can also be launched at the same time.

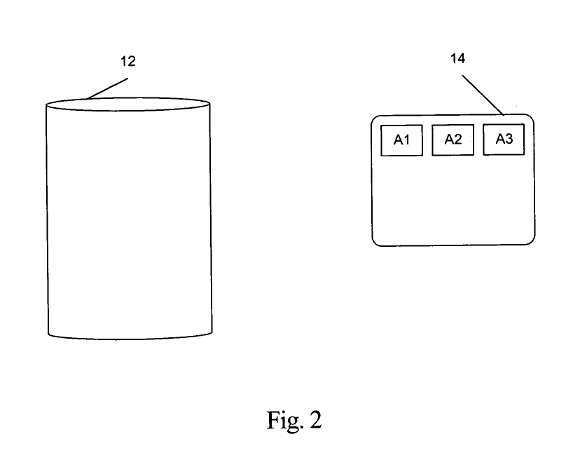

FIGS. 2 to 10 are drawings illustrating the preferred embodiment according to the present invention. In the preferred embodiment, the data management method according to the present invention is employed between a personal computer 12 and a digital camera 14. As shown in FIG. 2, there are three digital images A1, A2, and A3 in the digital camera 14. The three digital images are copied to the personal computer 12 for storage.

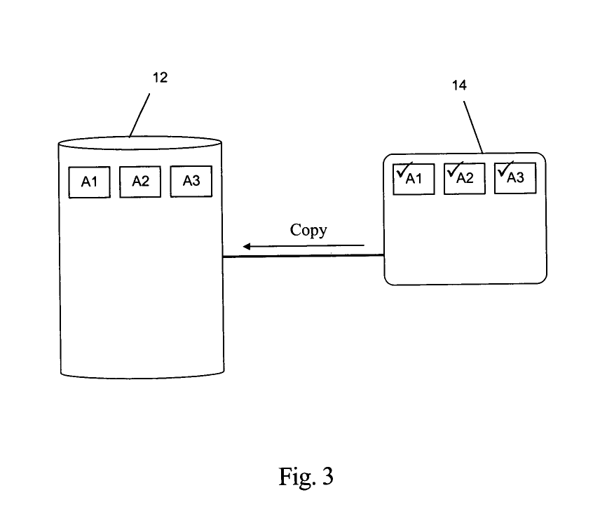

As shown in FIG. 3, when the digital camera 14 is connected to the personal computer 12, the digital images A1, A2, and A3 are copied to the personal computer 12 for storage. Meanwhile, a first marker is added to the digital images A1, A2, and A3 in the digital camera 14. Digital images with first markers represent digital images that have already been copied to the personal computer 12.

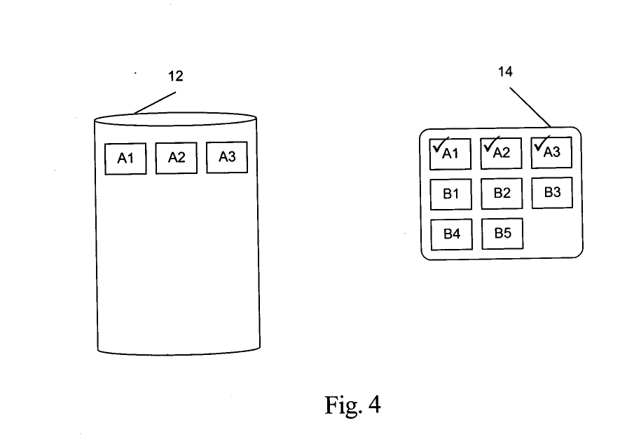

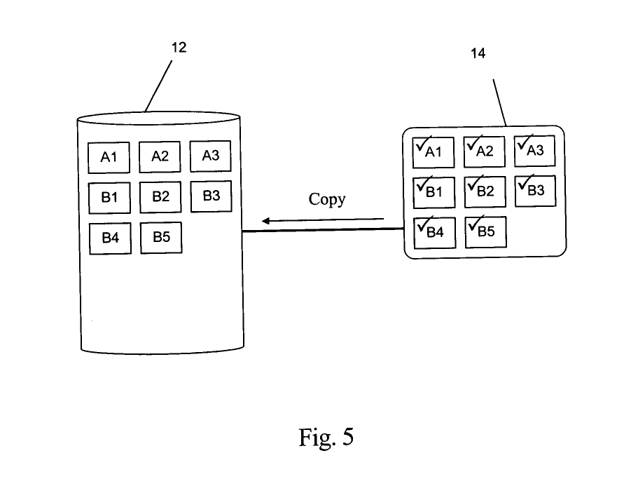

Next, as depicted in FIG. 4, the user uses the digital camera 14 for capturing additional digital images B1 to B5. When the user connects the digital camera 14 to the personal computer 12 again, digital images B1 to B5 without the first marker are added to the personal computer. Afterward, the first marker is also added to the digital images B1 to B5 in the digital camera 14, as shown in FIG. 5.

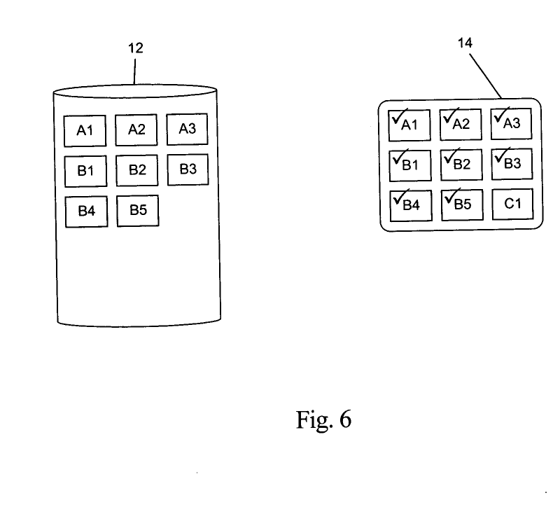

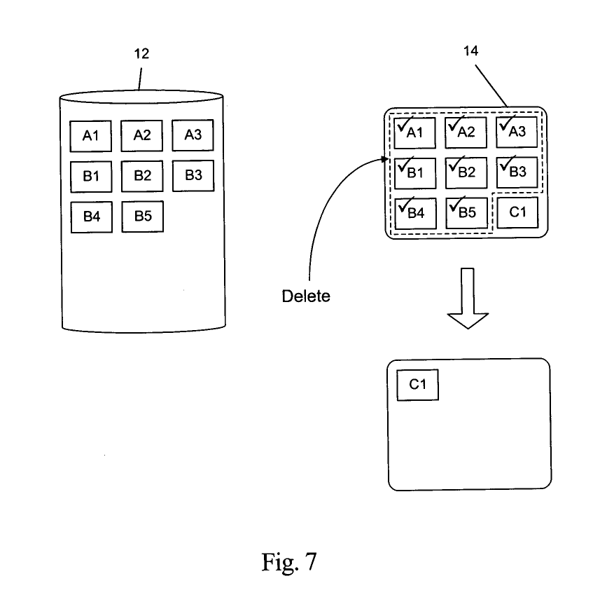

FIG. 6 shows that the storage capacity of the digital camera 14 is almost full when the user intends to capture more digital images. After saving the digital image C1, no more digital images can be captured and saved to the digital camera 14. As shown in FIG. 7, the user now can execute the delete function in the digital camera 14, and only the digital images with the first marker, such as A1 to A3 and B1 to B5, are deleted. The digital image C1, which is not designated with a first marker, is not deleted when the deletion function is performed. This mechanism guarantees that the not-yet-copied digital images are never mistakenly deleted.

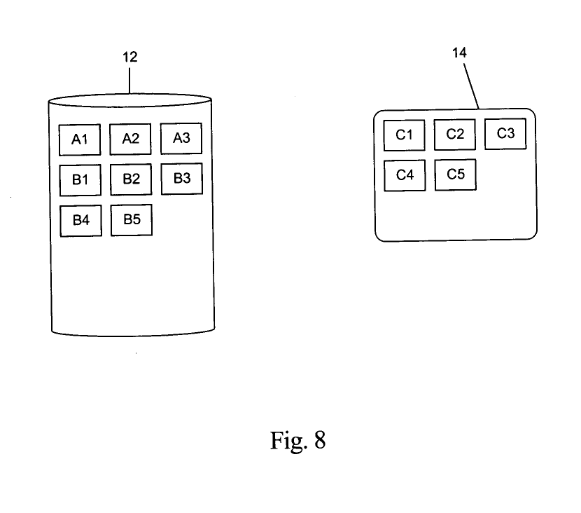

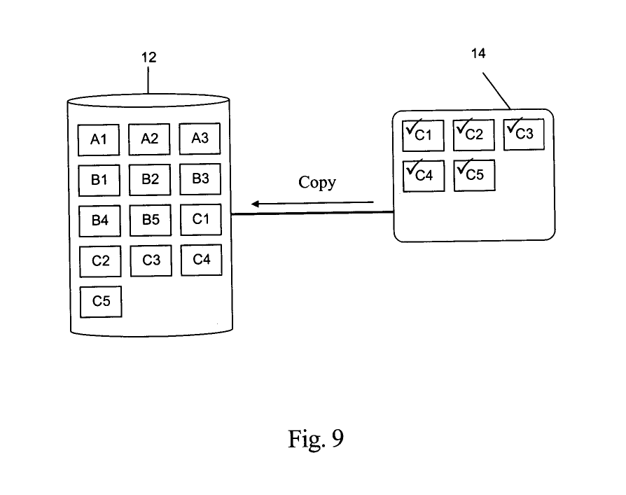

After executing the delete function, digital images with the first marker are deleted, and more storage capacity in the digital camera 14 is subsequently released for storing new digital images C2 to C5, as shown in FIG. 8. Next, in FIG. 9, when the user connects the digital camera 14 to the personal computer 12 again, the digital images C1 to C5 in the digital camera 14 are copied to the personal computer 12, and the first marker is added to the digital images C1 to C5.

Furthermore, the user can retain preferred digital images by adding a second marker. Digital images with the second marker are not deleted, whether or not the “locked” digital images have previously been copied to the personal computer 12. This way, the user can preserve the desired digital images in the digital camera 14, at least until the digital images are unlocked.

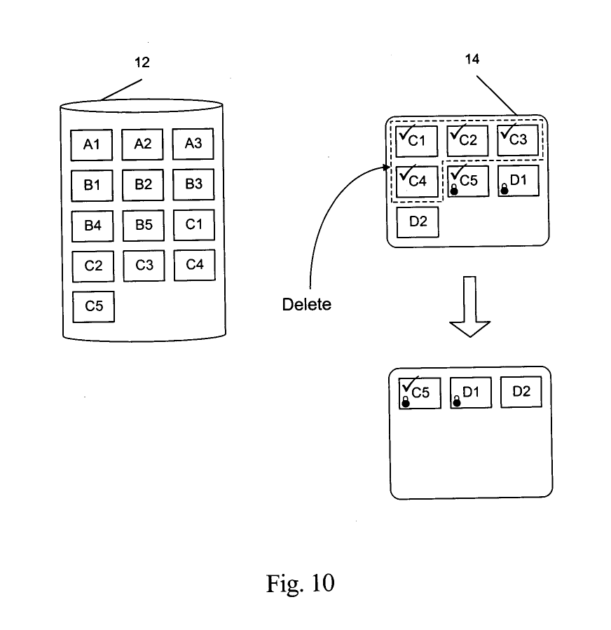

As shown in FIG. 10, if the user would like to retain the digital images C5 and D1 in the digital camera 14, he can add the second marker to those two digital images. When the user executes the delete function, only digital images C1 to C4 with the first marker but without the second marker are deleted.

Further, the deletion of the digital images with the first marker in the digital camera 14 can be performed automatically. For example, each time the digital camera 14 is connected to the personal computer 12 or each time the memory is full, the digital camera 14 automatically checks and deletes the digital images with the first marker. Therefore, the user does not have to perform the deletion function manually.

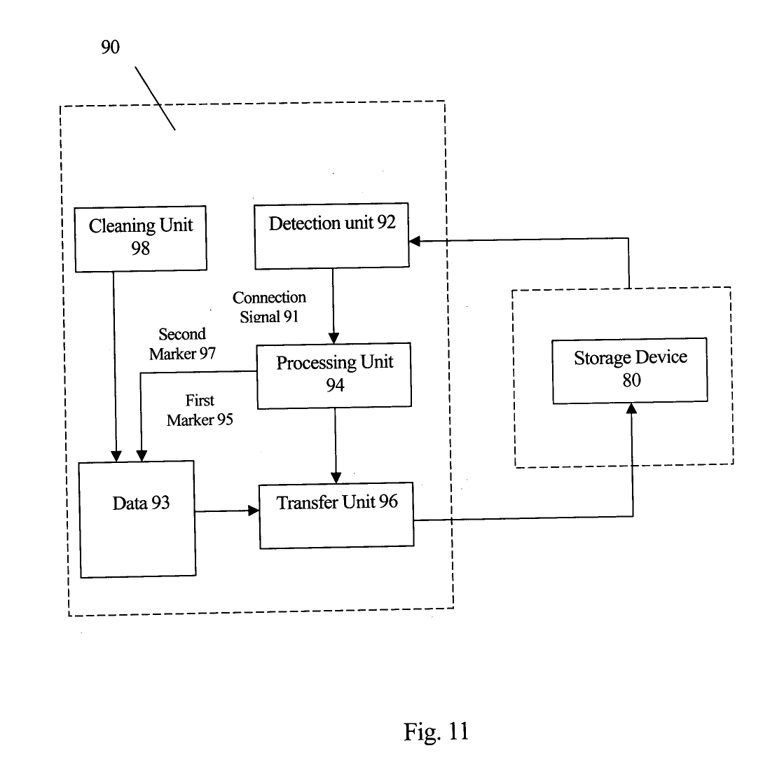

FIG. 11 is a block diagram illustrating the data capture/storage device according to the present invention. The data capture/storage device 90 has the data management function and includes a detection unit 92, a processing unit 94, and a transfer unit 96. The detection unit 92 connects to the processing unit 94 and detects the connection between the data capture/storage device 90 and a mass storage device 80. When the data capture/storage device 90 is connected to the mass storage device 80, the detection unit 92 generates a connection signal 91. The transfer unit 96 also connects to the processing unit 94. When the processing unit 94 receives the connection signal 91, the transfer unit 96 transfers the data files 93 in the data capture/storage device 90 to the mass storage device 80 via a transfer medium. Afterward, the processing unit 94 adds a first marker 95 to the data files 93 that have already been transferred to the mass storage device 80.

The data capture/storage device 90 can further include a cleaning unit 98. When the user triggers the cleaning unit 98, the cleaning unit 98 deletes the data files 93 bearing the first marker 95 in the data capture/storage device 90. Additionally, the processing unit 94 also adds a second marker 97 to the data files 93. The data files 93 with the second marker 97 are exempt from deletion when the user triggers the cleaning unit 98.

The data management method according to the present invention automatically backs up the data files in the data capture/storage device to a mass storage device. Additionally, a first marker is added to the data files in the data capture/storage device, so transferred data files are more easily differentiated from not-yet transferred data. Data files in the data capture/storage device can be transferred to the mass storage device automatically, and mistaken deletion of not yet transferred data files in the data capture/storage device can be avoided. Furthermore, the user can retain the preferred data files in the data capture/storage device by adding a second marker. The data files with the second marker are not erased when the user performs the deletion function, even if the locked data files have already been transferred to the mass storage device.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A data management method between a mass storage device and a data capture/storage device, the data capture/storage device including a plurality of data files, and the method including an option of adding a first marker to each data file, the data management method comprising the steps of:
generating a connection signal when the data capture/storage device is connected to the mass storage device;
transferring the data files in the data capture/storage device to the mass storage device via a transfer medium when the mass storage device and the data capture/storage device receive the connection signal; and
adding the first marker to each data file in the data capture/storage device.

2. The data management method of claim 1, further including the step of:
deleting the data file with the first marker in the data capture/storage device.

3. The data management method of claim 2, wherein the user deletes the data file with the first marker by a command.

4. The data management method of claim 2, wherein a second marker is optionally added to the data files in the data capture/storage device, and when deleting the data files, data files with the second marker are not deleted even if also marked with the first marker.

5. The data management method of claim 4, wherein the user deletes data files with the first marker but without the second marker by a command when deleting data files in the data capture/storage device.

6. The data management method of claim 1, wherein a storage capacity of the mass storage device is at least ten times the storage capacity of the data capture/storage device.

7. The data management method of claim 1, wherein the data capture/storage device is a digital image capture/storage device, a digital voice capture/storage device, a data scanner or a bar code scanner.

8. The data management method of claim 7, wherein the digital image capture/storage device is a digital camera, PDA, or camera mobile telephone.

9. The data management method of claim 1, wherein the mass storage device is a personal computer, a server, a network mass storage device, a photo printer with onboard storage, a media center mass storage device, a companion picture vault, or a removable mass storage device.

10. The data management method of claim 1, wherein the transfer medium is wired, wireless, USB (Universal Serial Bus), Firewire (IEEE-1394), a serial cable, WiFi wireless, Bluetooth wireless, or Internet.

11. The data management method of claim 10, wherein the transfer medium also recharges the data capture/storage device.

12. A data capture/storage device storing a plurality of data files, the data capture/storage device comprising:
a processing unit;
a detection unit connected to the processing unit for detecting a connection between the data capture/storage device and a mass storage device, and generating a connection signal when the data capture/storage device connects to the mass storage device; and
a transfer unit connecting to the processing unit for transferring the data files to the mass storage device via a transfer medium when the processing unit receives the connection signal;
wherein the processing unit adds a first marker to the data files transferred from the data capture/storage device to the mass storage device.

13. The data capture/storage device of claim 12, further including a cleaning unit, wherein when the cleaning unit is triggered, the data files with the first marker in the data capture/storage device are deleted.

14. The data capture/storage device of claim 12, wherein the processing unit optionally adds a second marker to the data files in the data capture/storage device, and the data files with the second marker are not deleted even if also marked with the first marker.

15. The data capture/storage device of claim 14, wherein the user deletes the data files with the first marker but without the second marker by a command when deleting the data files in the data capture/storage device.

16. The data capture/storage device of claim 12, wherein a storage capacity of the mass storage device is ten times or more than a storage capacity of the data capture/storage device.

17. The data capture/storage device of claim 12, wherein the data capture/storage device is a digital camera, a camera PDA, a camera mobile telephone, a data scanner, or a bar code scanner.

18. The data capture/storage device of claim 12, wherein the mass storage device is a personal computer, a server, a network mass storage device, a photo printer with onboard storage, a media center mass storage device, a companion picture vault, or a removable mass storage device.

19. The data capture/storage device of claim 12, wherein the transfer medium is wired, wireless, USB (Universal Serial Bus), Firewire (IEEE-1394), a serial cable, WiFi wireless, Bluetooth wireless, or Internet.

20. The data capture/storage device of claim 19, wherein the transfer medium also recharges the data capture/storage device.
